(19) United States
(12) Patent Application Publication
(10) Pub. No.: US 2024/0126592 A1
(43) Pub. Date: Apr. 18, 2024

(54) METHODS AND IOT DEVICE FOR EXECUTING USER INPUT IN IOT ENVIRONMENT

(71) Applicant: Samsung Electronics Co.,Ltd., Suwon-si (KR)

(72) Inventors: Saksham GOYAL, Bengaluru (IN); Sourabh TIWARI, Bengaluru (IN); Vinay Vasanth PATAGE, Bengaluru (IN)

(21) Appl. No.: 18/468,230

(22) Filed: Sep. 15, 2023

Related U.S. Application Data
(63) Continuation of application No. PCT/KR23/12589, filed on Aug. 24, 2023.

(30) Foreign Application Priority Data
Oct. 18, 2022 (KR) 202241059593

(51) Int. Cl. G06F 9/46

(52) U.S. Cl. CPC G06F 9/466

(57) ABSTRACT

Methods for executing a user input in an IoT environment by at least one IoT device. The method may include receiving a user input from a user of the IoT device to execute at least one task associated with the IoT device. The method may include determining a multimodal context of the IoT environment relevant to the at least one task associated with the IoT device based on the received user input. The method may include retrieving multimodal data of the IoT environment corresponding to the determined multimodal context. The method may include determining a task execution intensity for the task associated with the IoT device based on the retrieved multimodal data. The method may include executing the task associated with the at least one IoT device using the determined task execution intensity.

### CROSS-REFERENCE TO RELATED APPLICATION(S)

This application is a bypass continuation of International Application No. PCT/KR2023/012589, filed on Aug. 24, 2023, which is based on and claims priority to IN Patent Application No. 202241059593, filed on Oct. 18, 2022, in the India Intellectual Property Office, the disclosures of which are incorporated by reference herein in their entireties.

### BACKGROUND

### 1. Field

Certain example embodiments relate to an internet of things (IoT) environment, and for example to methods and/or IoT devices for executing a user input in the IoT environment.

### 2. Description of Related Art

Currently, smart devices or IoT devices are capable to handle a user input (e.g., voice command, user query, gesture or the like) accurately. However, the smart devices or the IoT devices fail to recognize the severity of a situation in an IoT environment. Thus, producing a same result or same outcome for every situation in the IoT environment. Controlling an intensity of execution based on the severity of the situation is essential for every smart device or the IoT device to be cognitively intelligent.

FIG. 1 is an example scenario (100) in which existing systems/existing methods do not consider a scenario or the situation what a user is cooking, according to prior art.

As shown in FIG. 1, the user gives a command “turn on chimney” while cooking a food. Based on the command, the chimney may start with a pre-set speed or a default speed. As the user identified that the pre-set speed or the default speed is not enough to clear smoke being generated during the cooking, the user will give a follow up command to increase speed.

Further, a contextual command by the user produces the same result for any type of cooking (e.g. shallow fry, deep fry etc.). This results in an undesired user experience.

FIG. 2 to FIG. 4 are example scenarios (200-400) in which the existing systems/existing methods do not consider the scenario what's a user environment, according to prior art.

As shown in the FIG. 2, consider the scenario “a Kid has spilled water/milk on a floor” and the user provides the command as “Clean the floor here” to the IoT device (e.g., robot vacuum cleaner or the like). Based on the command, the IoT device has swept the floor. But, the existing systems/existing methods do not consider the scenario what's the user environment. Further, the user needs to provide a follow-up command to the IoT device for changing the intensity of the command. Despite, the IoT device executing user command, the IoT device fails to recognize a presence of human activity in vicinity and thus, leaving the floor wet that the user can have hazardous effect. This results in the undesired the user experience.

As shown in the FIG. 3, the user provides the command as “Play <XYZ> song on a music application (e.g., Spotify® or the like)” running in the IoT device (e.g., smart phone). Based on the command, the IoT device plays the <XYZ> song on the music application with a pre-defined volume, wherein the pre-defined volume is very less. As the pre-defined volume is very less, the user again provides the command as “I cannot hear, be louder/increase the volume” to the IoT device. Based on the command again, the volume is increased by the music application.

In the existing systems/existing methods, the contextual command by the user produces the same speaker volume regardless of a contextual situation of the user. The contextual situation can be for example, but not limited to “the user is in a karaoke party” or “the user is doing working from home” or “someone sleeping next room of the user”. This results in an undesired user experience.

As shown in FIG. 4, the user provides the command as “Open the window” to a virtual assistance running in the IoT device. Based on the command, the virtual assistance opens the window completely. The current systems/existing methods do not consider the scenario what's the user environment. Hence, the user needs to provide a follow-up command to further change the intensity. That is, after opening the window completely, the user feels too much light/wind. Hence, the user again provides the command as “close the window by half” to the virtual assistance running in the IoT device.

FIG. 5 is an example scenario (500) in which the current systems/existing methods do not consider a presence of humans at a home and their relative positioning to a door intercom speaker at the home, according to prior art. As shown in the FIG. 5, the user speaks into the door intercom speaker. The door intercom speaker rings with pre-defined intensity of sound level and with pre-defined repetition. The existing methods/current systems do not consider the presence of humans at the home and their relative positioning to the door intercom speaker at the home. Thus, the user needs to provide the follow-up command to further change the intensity. This results in the undesired user experience.

It is desired to address the above mentioned disadvantages or other short comings or at least provide a useful alternative.

### SUMMARY

Certain example embodiments disclose methods and/or an IoT device for executing a user input (e.g., user command, user gesture, and user query) in an IoT environment.

Certain example embodiments understand the user input (e.g., voice command or the like) to execute at least one task/action associated with at least one IoT device in the IoT environment and determine multimodal context of the IoT environment relevant to the at least one executed task/action and the IoT device to intelligently decide action/functional/task execution intensity.

Certain example embodiments use multimodal inputs (e.g., obtained from at least one of user's gesture, Ultra-wideband (UWB) positions, IoT device data, sensors, camera feed, voice assistant, non-speech sound etc.), along with the user's input to predict if an action/functional/task intensity can be determined for safe/enhanced operation of the IoT device.

Certain example embodiments determine the action/task/functional intensity for the at least one task/action associated with the at least one IoT device based on the multimodal input and execute the at least one task/action associated with the at least one IoT device using the determined action/task/functional intensity.

Certain example embodiments enhance user experience by executing the user command by taking in to a multimodal intelligence at the time of receiving the voice command and thereby determining optimal action/functional/task execution intensity for executing the user command.

Certain example embodiments disclose methods for executing a user input (e.g., user command, user gesture, and user query) in an IoT environment. The method may include receiving, by at least one IoT device, the user input from a user of the at least one IoT device to execute at least one task associated with the at least one IoT device in the IoT environment. Further, the method may include acquiring, by the at least one IoT device, multimodal data of the IoT environment based on the user input. Further, the method may include predicting, by the at least one IoT device, a task execution intensity for the at least one task associated with the at least one IoT device based on the user input and the multimodal data. Further, the method may include executing, by the at least one IoT device, the at least one task associated with the at least one IoT device with the predicted task execution intensity.

In an example embodiment, the method may include monitoring, by the at least one IoT device, the task execution intensity for the at least one task as a feedback over a period of time. Further, the method may include executing, by the at least one IoT device, the at least one task associated with the at least one IoT device based on the feedback.

In an example embodiment, acquiring, by the at least one IoT device, the multimodal data of the IoT environment may include determining, by the at least one IoT device, a multimodal context of the IoT environment relevant to the at least one task associated with the at least one IoT device based on the received user input, and acquiring, by the at least one IoT device, the multimodal data of the IoT environment corresponding to the determined multimodal context.

In an example embodiment, the multimodal context may include at least one of a context of the user, a context of the at least one IoT device and an ambient context. The context of the user context may be determined from one or more derived input from the multimodal data, pertaining to a user activity, and state of connected IoT devices. The ambient context may be determined from one or more derived inputs from IoT device data, non-speech scene detection, sensory output, and an external parameter.

In an example embodiment, the multimodal data may include at least one of a gesture of the user, Ultra-wideband (UWB) position of the at least one IoT device, data associated with the at least one IoT device, at least one sensor input, feed associated with an imaging device, voice assistant information, non-speech information or the like.

In an example embodiment, the task execution intensity may include at least one of a functional mode of the at least one IoT device, a position of the at least one IoT device, a movement of the at least one IoT device, and a control function of the at least one IoT device.

In an example embodiment, the multimodal data may be acquired by receiving at least one of the user input, a gesture of the user, UWB position of the at least one IoT device, data associated with the at least one IoT device, at least one sensor input, feed associated with an imaging device, voice assistant information, and non-speech information to generate the multimodal data, and converting and normalizing the generated multimodal data.

In an example embodiment, the multimodal data may be acquired by mapping of a wearable device in the IoT environment and at least one sensor data in the IoT environment to obtain a current environment state of the user and the at least one IoT device, obtaining a position information of the user and the at least one IoT device using a UWB data, obtaining a current operational state of the at least one IoT device using an IoT data, obtaining a content and operation intensity status using data from an imaging device and a non-speech feed, and acquiring the multimodal data based on the current environment state of the user, the current environment state of the at least one IoT device, the obtained position information of the user and the at least one IoT device, the obtained current operational state of the at least one IoT device and the obtained content and operation intensity status.

In an example embodiment, the multimodal data may be updated over a period of time, using a data driven model, based on at least one of the user behaviour, a user usage pattern and the at least one IoT device, where the multimodal data is processed using a map reduction technique.

In an example embodiment, the task execution intensity may be determined using a machine learning (ML) based technique, a Random forest technique, a clustering based technique, a decision tree based classifier or the like. The task execution intensity may be determined based on at least one of capability of the at least one IoT device, a state of the at least one IoT device and an execution control data associated with the at least one IoT device.

Accordingly, example embodiments herein may disclose methods for executing a user input in an IoT environment. The method may include receiving, by at least one IoT device, a user input from a user of the at least one IoT device to execute at least one task associated with the at least one IoT device in the IoT environment. Further, the method may include determining, by the at least one IoT device, a multimodal context of the IoT environment relevant to the at least one task associated with the at least one IoT device based on the received user input. Further, the method may include retrieving, by the at least one IoT device, multimodal data of the IoT environment corresponding to the determined multimodal context. Further, the method may include predicting & determining, by the at least one IoT device, a task execution intensity for the at least one task associated with the at least one IoT device based on the retrieved multimodal data. Further, the method may include executing, by the at least one IoT device, the at least one task associated with the at least one IoT device using the predicted and determined task execution intensity.

Accordingly, example embodiments herein may disclose an IoT device including a processor comprising processing circuitry, a memory storing at least one of a state of the IoT device and an activity of the IoT device, and a multimodal input based task controller, comprising processing circuitry, coupled, directly or indirectly, with the processor and the memory. The multimodal input based task controller may be configured to receive the user input from a user of the at least one IoT device to execute at least one task associated with the at least one IoT device in the IoT environment. Further, the multimodal input based task controller may be configured to acquire multimodal data of the IoT environment based on the user input. Further, the multimodal input based task controller may be configured to predict a task execution intensity for the at least one task associated with the at least one IoT device based on the user input and the multimodal data. Further, the multimodal input based task controller may be configured to execute the at least one task associated with the at least one IoT device with the predicted task execution intensity.

Accordingly, example embodiments herein may disclose an IoT device including a processor, a memory storing at least one of a state of the IoT device and an activity of the IoT device, and a multimodal input based task controller coupled, directly or indirectly, with the processor and the memory. The multimodal input based task controller may be configured to receive a user input from a user of the at least one IoT device to execute at least one task associated with the at least one IoT device in the IoT environment. Further, the multimodal input based task controller may be configured to determine a multimodal context of the IoT environment relevant to the at least one task associated with the at least one IoT device based on the received user input. Further, the multimodal input based task controller may be configured to retrieve multimodal data of the IoT environment corresponding to the determined multimodal context. Further, the multimodal input based task controller may be configured to determine a task execution intensity for the at least one task associated with the at least one IoT device based on the retrieved multimodal data. Further, the multimodal input based task controller may be configured to execute the at least one task associated with the at least one IoT device using the determined task execution intensity.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the scope thereof, and the example embodiments herein include all such modifications.

### BRIEF DESCRIPTION OF THE DRAWINGS

Example embodiments herein are illustrated in the accompanying drawings, throughout which like reference letters indicate corresponding parts in the various figures. The embodiments herein will be better understood from the following description with reference to the drawings, in which:

FIG. 1 is an example scenario in which an existing systems/existing methods do not consider a scenario what a user is cooking, according to prior art;

FIGS. 2, 3 and 4 are example scenarios in which the existing systems/existing methods do not consider the scenario what is a user environment, according to prior arts;

FIG. 5 is an example scenario in which the existing systems/existing methods do not consider a presence of humans at a home and their relative positioning to a door intercom speaker at the home, according to prior art;

FIG. 6 shows various hardware components of an IoT device, according to an example embodiment;

FIG. 7 is a flow chart illustrating a method for executing a user input (e.g., user command, user gesture, user query or the like) in an IoT environment, according to an example embodiment;

FIG. 8 shows various hardware components of a multimodal input based task controller included in the IoT device, according to an example embodiment;

FIG. 9 and FIG. 10 are example illustrations in which an output of a multi-modal input (MMI) analyzer in the multimodal input based task controller for different user commands and scenes are explained, according to an example embodiment;

FIG. 11 and FIG. 12 are example illustrations in which operations of the MMI analyser is depicted, according to an example embodiment;

FIG. 13 is an example illustration in which an artificial intelligence (AI) model is trained with MMI data based on user's command and target IoT devices, according to an example embodiment;

FIG. 14 is an example illustration in which operations of an intensity prediction is explained, according to an example embodiment;

FIG. 15 is an example illustration in which operations of an intensity prediction engine in the multimodal input based task controller is explained, according to an example embodiment;

FIG. 16 is an example scenario in which operations of an intensity action determiner in the multimodal input based task controller is explained, according to an example embodiment;

FIG. 17 is an example scenario in which situational execution intensity prediction is explained, according to an example embodiment;

FIG. 18 is an example scenario in which situation execution intensity prediction based on more than one target IoT device is explained, according to an example embodiment;

FIG. 19 is an example scenario in which the situation execution intensity prediction is explained based on an identified human presence and an activity, according to an example embodiment;

FIG. 20 is an example scenario in which dynamic execution intensity prediction is explained, according to an example embodiment;

FIG. 21 and FIG. 22 are example illustrations in which situational execution intensity determination is explained based on multi-modal input data received at the moment of reception of the user command, according to an example embodiment;

FIG. 23 to FIG. 28 are example scenarios in which execution intensity is determined by correlation of multi-modal data input with the user command, according to an example embodiment; and

FIG. 29 and FIG. 30 are another example scenarios in which situational execution intensity determination is depicted based on multi-modal input data received at the moment of reception of the user command, according to an example embodiment.

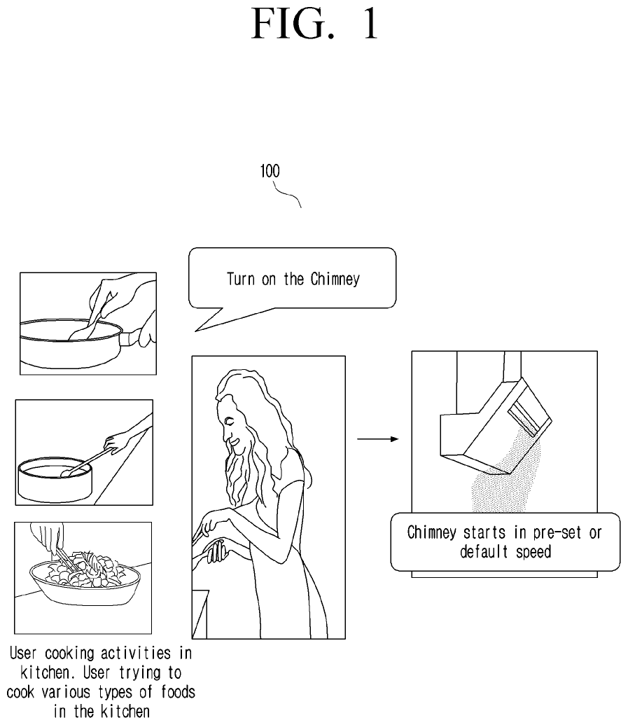

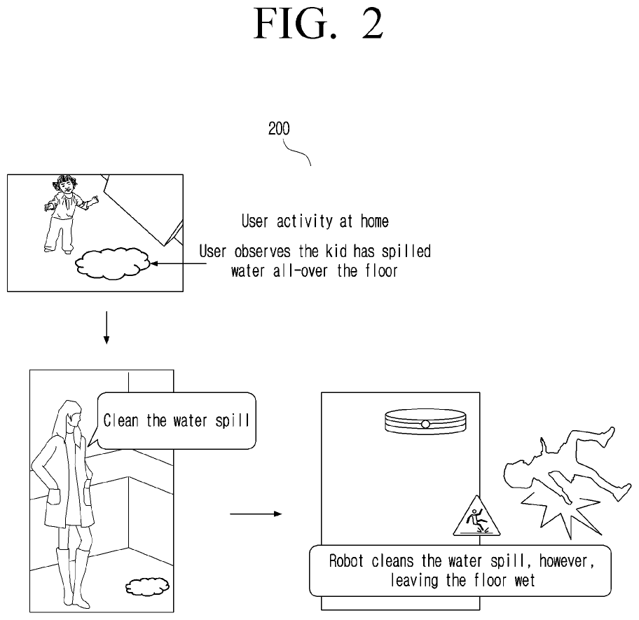

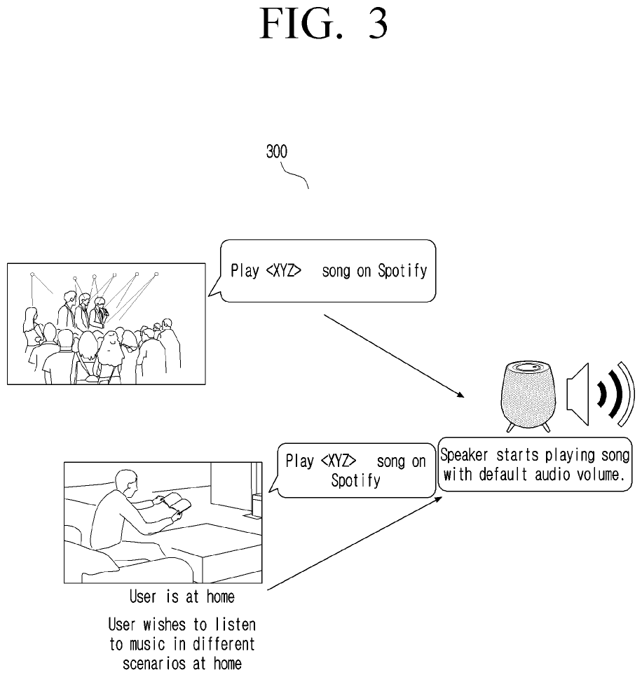

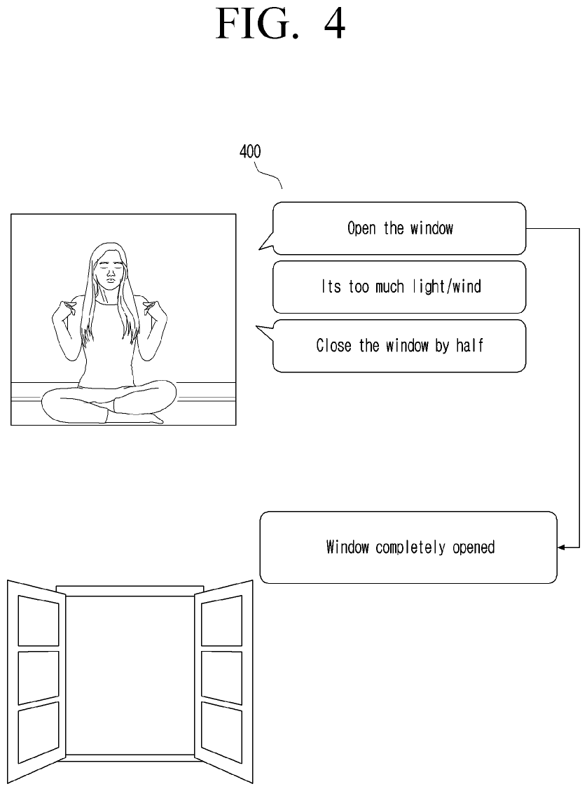

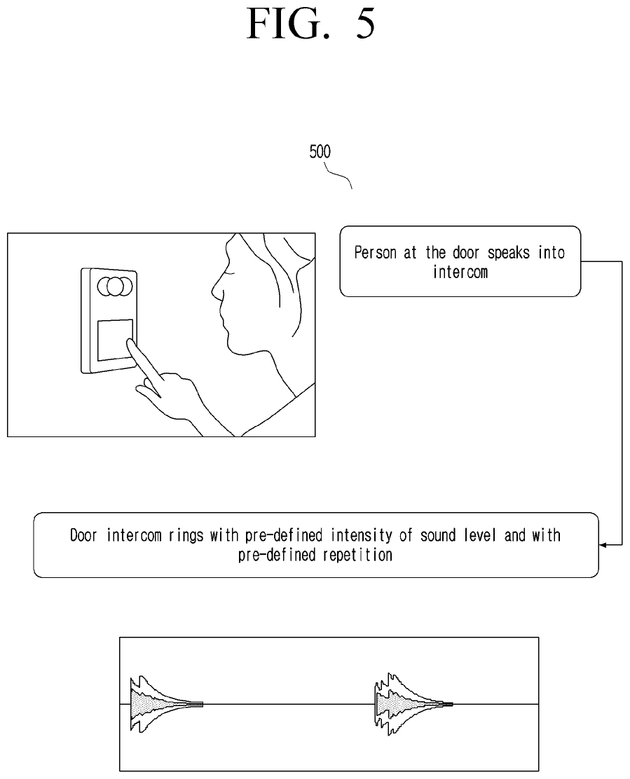

### DETAILED DESCRIPTION

The example embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

The terms “command”, “query” and “input” are used interchangeably in the patent disclosure. The terms “task”, “functional” and “action” are used interchangeably in the patent disclosure.

The embodiments herein achieve methods for executing a user input in an IoT environment. The method may include receiving, by at least one IoT device, the user input from a user of the at least one IoT device to execute at least one task associated with the at least one IoT device in the IoT environment. Further, the method may include acquiring, by the at least one IoT device, multimodal data of the IoT environment based on the user input. Further, the method may include predicting, by the at least one IoT device, a task execution intensity for the at least one task associated with the at least one IoT device based on the user input and the multimodal data. Further, the method may include executing, by the at least one IoT device, the at least one task associated with the at least one IoT device with the predicted task execution intensity.

Unlike conventional methods and systems, the proposed method can be used to enhance the user experience by executing a received user input (e.g., voice command or the like) by taking in to multimodal intelligence at the time of receiving the voice command and thereby determining optimal task execution intensity for executing the received voice command, and provides better execution based responses to the user. The user of the IoT device does not need to give follow up command to get desired results. This results in enhancing the user experience.

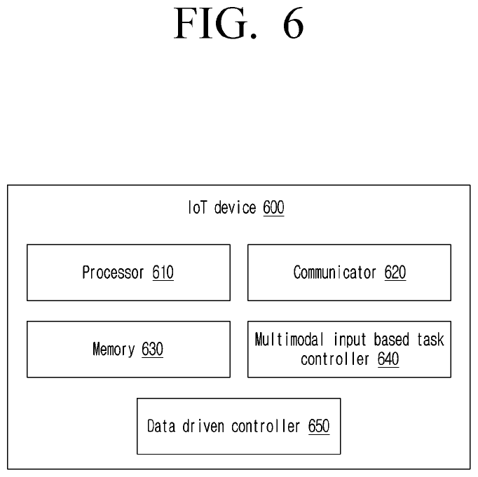

Referring now to the drawings, and more particularly to FIGS. 6 through 28, where similar reference characters denote corresponding features consistently throughout the figures, there are shown example embodiments.

FIG. 6 shows various hardware components of an IoT device (600), according to an example embodiment. The IoT device (600) can be, for example, but not limited to a smart laptop, a smart computer, a smart Device-to-Device (D2D) device, a smart vehicle to everything (V2X) device, a smartphone, a smart foldable phone, a smart TV, an immersive device, a smart chimney, a smart light, a smart door, a smart refrigerator, a smart washing machine, a smart oven, a smart stove or the like. In an embodiment, the IoT device (600) may include a processor (610), a communicator (620), a memory (630), a multimodal input based task controller (640), and a data driven controller (650). The processor (610) is communicatively coupled, directly or indirectly, with the communicator (620), the memory (630), the multimodal input based task controller (640), and the data driven controller (650).

The multimodal input based task controller (640) receives a user input from a user of the at least one IoT device (600) to execute at least one task or action associated with the at least one IoT device (600) in the IoT environment. The user input can be, for example, but not limited to a voice command, a text input, a gesture, or the like. Based on the received user input, the multimodal input based task controller (640) determines the multimodal context of the IoT environment relevant to the at least one task associated with the at least one IoT device (600). The multimodal context can be, for example, but not limited to a context of the user, a context of the at least one IoT device (600) and an ambient context. The context of the user context is determined from one or more derived input from the multimodal data, pertaining to a user activity, and state of connected IoT devices. The ambient context is determined from one or more derived inputs from IoT device data, non-speech scene detection, sensory output, and external parameter(s) (e.g., weather, temperature, traffic or the like).

Further, the multimodal input based task controller (640) acquires the multimodal data of the IoT environment corresponding to the determined multimodal context. The multimodal data can be, for example, but not limited to a gesture of the user, Ultra-wideband (UWB) position of the at least one IoT device (600), data associated with the at least one IoT device (600), at least one sensor input, feed associated with an imaging device (e.g., camera or the like), voice assistant information, and non-speech information.

In an embodiment, the multimodal data is acquired by receiving at least one of the user input, the gesture of the user, the UWB position of the at least one IoT device (600), the data associated with the at least one IoT device (600), at least one sensor input, feed associated with the imaging device, voice assistant information, and non-speech information to generate the multimodal data, and converting and normalizing the generated multimodal data.

In another embodiment, the multimodal data is acquired by mapping of a wearable device (e.g., smart watch, smart band or the like) in the IoT environment and at least one sensor data in the IoT environment to obtain a current environment state of the user and the at least one IoT device (600), obtaining a position information of the user and the at least one IoT device (600) using the UWB data, obtaining a current operational state of the at least one IoT device (600) using the IoT data, obtaining a content and operation intensity status using data from the imaging device and a non-speech feed, and acquiring the multimodal data based on the current environment state of the user, the current environment state of the at least one IoT device (600), the obtained position information of the user and the at least one IoT device (600), the obtained current operational state of the at least one IoT device (600) and the obtained content and operation intensity status.

The multimodal data is updated over a period of time, using a data driven model, based on at least one of the user behaviour, a user usage pattern and the at least one IoT device (600), wherein the multimodal data is processed using a map reduction technique. The data driven model can be a ML model or AI model handled by the data driven controller (650).

Based on the user input and the multimodal data, the multimodal input based task controller (640) predicts the task execution intensity for the at least one task associated with the at least one IoT device (600). The task execution intensity can be, for example, but not limited to a functional mode of the at least one IoT device (600), the position of the at least one IoT device (600), a movement of the at least one IoT device (600), and a control function of the at least one IoT device (600). The task execution intensity is determined using at least one of an Artificial intelligence (AI) or a machine learning (ML) based techniques such as Random forest technique, a clustering based technique, a state of the at least one IoT device (600), and a decision tree based classifier etc. The task execution intensity is determined based on at least one of capability of the at least one IoT device (600) and an execution control data associated with the at least one IoT device (600).

Further, the multimodal input based task controller (640) executes the at least one task associated with the at least one IoT device (600) with the predicted task execution intensity. Further, the multimodal input based task controller (640) monitors the task execution intensity for the at least one task as a feedback over a period of time. Based on the feedback, the multimodal input based task controller (640) calibrates/alters/executes the at least one task associated with the at least one IoT device (600).

The multimodal input based task controller (640) is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

Further, the processor (610) may be configured to execute instructions stored in the memory (630) and to perform various processes. The communicator (620) may be configured for communicating internally between internal hardware components and with external devices via one or more networks. The memory (630) also stores instructions to be executed by the processor (610). The memory (630) stores at least one of the state of the IoT device (600) and an activity of the IoT device (600). The memory (630) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (630) may, in some examples, be considered a non-transitory storage medium. The term “non-transitory” may indicate that the storage medium is not embodied in a carrier wave or a propagated signal. However, the term “non-transitory” should not be interpreted that the memory (630) is non-movable. In certain examples, a non-transitory storage medium may store data that can, over time, change (e.g., in Random Access Memory (RAM) or cache).

Further, at least one of the plurality of modules/controller may be implemented through the AI model/ML model using the data driven controller (650). The data driven controller (650) can be a ML or AI model based controller. A function associated with the AI model may be performed through the non-volatile memory, the volatile memory, and the processor (610). The processor (610) may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or AI model stored in the non-volatile memory and the volatile memory. The predefined operating rule or artificial intelligence model is provided through training or learning.

Here, being provided through learning indicates that a predefined operating rule or AI model of a desired characteristic is made by applying a learning algorithm to a plurality of learning data. The learning may be performed in a device itself in which AI according to an embodiment is performed, and/or may be implemented through a separate server/system.

The AI model may comprise of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although FIG. 6 shows various hardware components of the IoT device (600) but it is to be understood that other embodiments are not limited thereon. In other embodiments, the IoT device (600) may include less or more number of components. Further, the labels or names of the components are used only for illustrative purpose and does not limit the scope. One or more components can be combined together to perform same or substantially similar function in the IoT device (600).

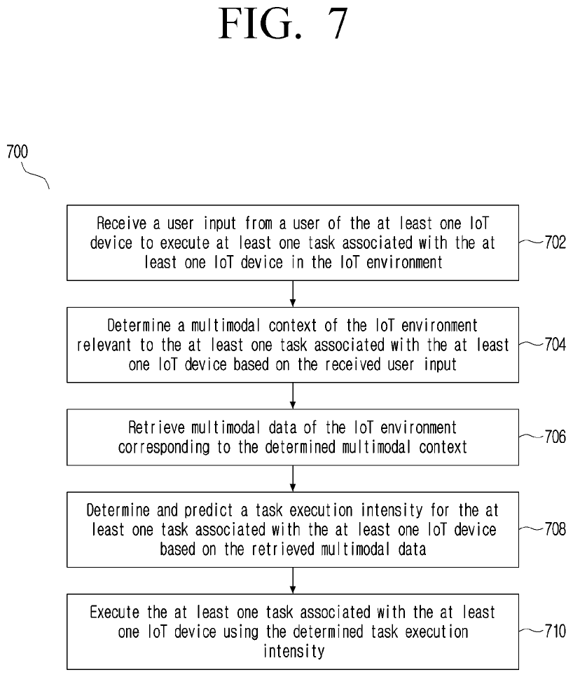

FIG. 7 is a flow chart (700) illustrating a method for executing the user input in the IoT environment, according to an example embodiment. The operations (702-710) are performed by the multimodal input based task controller (640).

At 702, the method may include receiving the user input from the user of the at least one IoT device (600) to execute the at least one task associated with the at least one IoT device (600) in the IoT environment. At 704, the method may include determining the multimodal context of the IoT environment relevant to the at least one task associated with the at least one IoT device (600) based on the received user input. At 706, the method may include retrieving the multimodal data of the IoT environment corresponding to the determined multimodal context. At 708, the method may include determining and predicting the task execution intensity for the at least one task associated with the at least one IoT device (600) based on the retrieved multimodal data. At 710, the method may include executing the at least one task associated with the at least one IoT device (600) using the determined task execution intensity.

The proposed method can be used to enhance the user experience by executing the received voice command by taking into the multimodal intelligence at the time of receiving the voice command and thereby determining optimal task execution intensity for executing the received voice command. The proposed method can be used to find the correlation between voice command and multi-modal input. The proposed method can be used to determine and predict the execution intensity using deep learning models for enhanced accuracy.

The various actions, acts, blocks, steps, or the like in the flow chart (700) may be performed in the order presented, in a different order or simultaneously. Further, in some embodiments, some of the actions, acts, blocks, steps, or the like may be omitted, added, modified, skipped, or the like without departing from the scope.

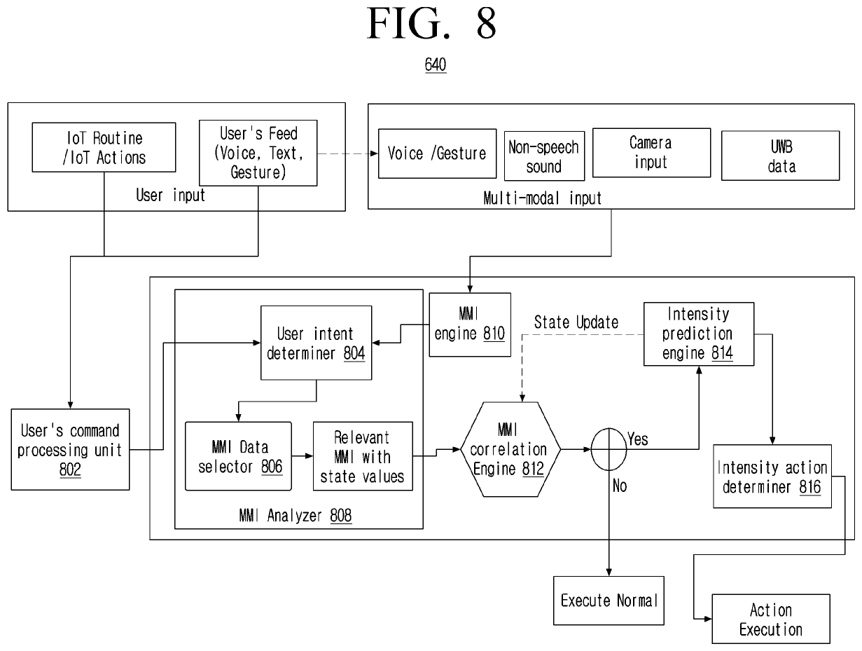

FIG. 8 shows various hardware components of the multimodal input based task controller (640) included in the IoT device (600), according to an example embodiment. In an embodiment, the multimodal input based task controller (640) may include a user command processing unit (802) comprising processing circuitry, a user intent determiner (804) comprising processing circuitry, a MMI data selector (806) comprising circuitry, a MMI analyzer (808) comprising circuitry, a MMI engine (810) comprising circuitry, a MMI correlation engine (812) comprising circuitry, an intensity prediction engine (814) comprising circuitry and an intensity action determiner (816) comprising circuitry, wherein the user intent determiner (804) and the MMI data selector (806) may be included in the MMI analyzer (808).

The user command processing unit (802) receives the user input (e.g., voice command or the like) and passes the user input into the user intent determiner (804). The user command processing unit (802) has a capability of an automatic speech recognition (ASR) and a natural language processing (NLP).

The user intent determiner (804) determines the intention, what the user wants to achieve through the user input. In an example, for same user command of “turn on the chimney”, the user intent can be different. The user can feel that a smoke level is high, and thus the user wants to turn on the chimney, or the user wants to start the chimney to remove cooking a food smell from a home, or the user just want to start the chimney as the food is cooking. The intent can be determined using the multi modal input data available from various IoT devices (e.g. surrounding IoT devices) and sensors in the home. The user's command and the target IOT device are correlated with the MMI data to determine the user's intent. In an example, a decision tree based classifier can be used to determine the user's intent.

The MMI analyzer (808) takes the user's command, from the user intent determiner (804). The MMI engine (810) provides MMI data related to the user's command using the target device. Further, the MMI analyzer (808) determines the user intent, or reason why the user gave this command, and what the user wants to achieve. Further, the MMI analyzer (808) also determines that how to use only relevant MMI data from a large MMI data to accurately predict the functional intensity on the target IoT devices. Thus, the MMI analyzer (808) helps in reducing the large MMI data to small relevant subset.

The MMI engine (810) reads the all available MMI data such as user's data, device's data, ambient data etc. by way of application programming interfaces (APIs), sensors, IoT smart things data etc. The MMI engine (810) provides the MMI data in a format (e.g., comma-separated values (CSV) table format or the like), which can be used as input to the ML model.

The MMI data selector (806) determines a relevant set of data which is useful in predicting the task execution intensity. Not all the MMI data is helpful, so that the MMI data selector (806) helps in selecting only the relevant data based on the target IoT devices and user's intent. In an example, if the user's intent is to turn on the chimney to reduce smoke, then only smoke level MMI can help in setting up of intensity level. Similarly if the user wants to reduce a food smell, then food type and smoke level MMI data is required to set the intensity level. Alternatively, a map-reduce database (DB) table, trained with user's survey, predefined rules, crowd sourcing data etc. can be used for determining the relevant set of data which is useful in predicting the task execution intensity. As every user has different set of device and sensors in the home, a Reinforcement learning is used to personalize the map-reduce DB table for different users.

Further, for the relevant MMI with state values, the MMI data selector (806) provides a MMI data category, such as smoke level, food type etc. Further, IoT devices and sensors can be different for different homes, so the MMI engine (810) finds the relevant set of data which is useful in predicting the task execution intensity based on the MMI data category. If the MMI engine (810) is not able to find sensors/target IoT devices, the MMI engine (810) learns from user's action, and updates the Map-Reduce table. The Map-Reduce table in form of the CSV is the output of the MMI analyzer (808). Only relevant MMI data which can be used for accurate prediction of the functional intensity will be send along with the current state values to the MMI correlation engine (812).

The MMI correlation engine (812) and the intensity prediction engine (814) predict the execution intensity based on the target IoT device, the user command and the relevant MMI data. The MMI correlation engine (812) finds/determines, if the user command and the MMI data can be used for predicting execution intensity or not. If an output is YES, then the intensity prediction engine (814) is used to predict the execution intensity. Also, the MMI correlation engine (812) takes natural language understanding (NLU) results of the user's command and MMI engine's data as input, and predicts if a correlation exists or not. In an example, if the user asks “How is weather in Suwon?”. The command (e.g., How is weather in Suwon?) do not need the MMI data, but command like “open the window/start the chimney” requires the MMI data, as the operation result can be set better with the MMI data. In an embodiment, the MMI correlation engine (812) can be a machine learning model, which can be built using any clustering based techniques or decision tree based classifiers. The MMI correlation engine (812) takes the MMI data and determines for meaningful relationship, if a relationship exists. The MMI correlation engine (812) fetches a data from predefined default value list, provides outcome of the relationship and shares the relationship further to the intensity prediction engine (814).

The MMI data selector (806), the MMI analyzer (808), the MMI engine (810), the MMI correlation engine (812), the intensity prediction engine (814) are physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

Although FIG. 8 shows various hardware components of the multimodal input based task controller (640) but it is to be understood that other embodiments are not limited thereon. In other embodiments, the multimodal input based task controller (640) may include less or more number of components. Further, the labels or names of the components are used only for illustrative purpose and does not limit the scope. One or more components can be combined together to perform same or substantially similar function in the multimodal input based task controller (640).

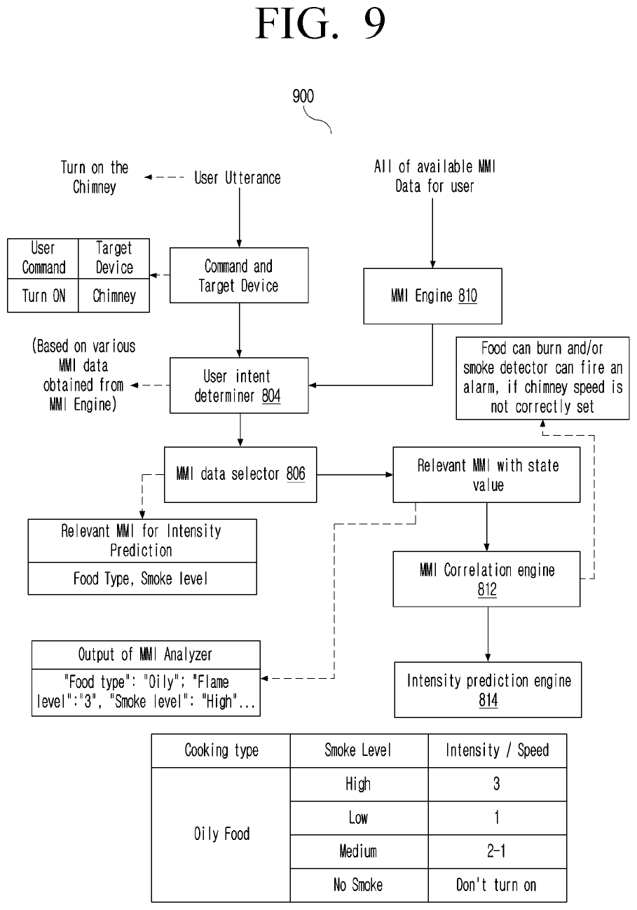

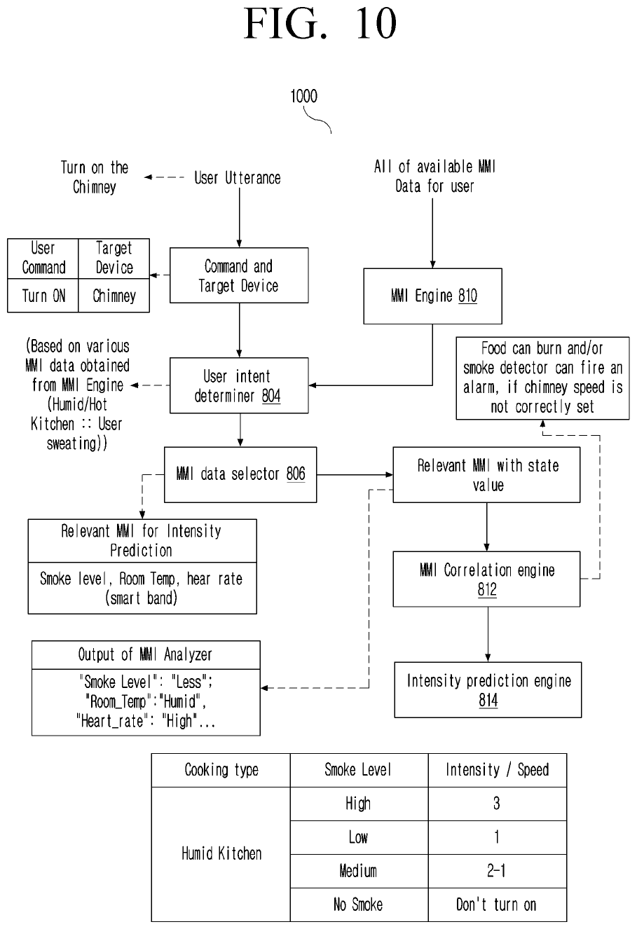

FIG. 9 and FIG. 10 are example illustrations (900 and 1000) in which the output of the MMI analyzer (808) for different user commands and scenes are explained, according to an example embodiment.

As shown in the FIG. 9, consider the scenario, the user is cooking an oily food on a kitchen hob and the smoke level is high. The user provides the input as “Turn on the Chimney”. Based on the user input, the user command is “Turn ON” and the target IoT device is “Chimney”. Further, a MMI user intent prediction engine (not shown) predicts the intent of the user command as “Smokey kitchen”. Further, the MMI data selector (806) determines that Relevant MMI for the intensity prediction as “Food Type, and Smoke level”. Based on the relevant MMI, a state value will be “Food type: “Oily”; “Flame level:3”, “Smoke level: High”. Further, the MMI correlation engine (812) provides the correlation as “food can burn and/or a smoke detector can trigger an alarm, if a chimney speed is not correctly set”. Further, based on the relevant MMI and the intensity prediction, the intensity prediction engine (814) provides the output as turn on the chimney to reduce the smoke. Based on the proposed method, the method can accurately predict the intensity level of the chimney fan speed based on the detected user intention.

As shown in the FIG. 10, consider the scenario, the user is cooking the food in a humid condition, and asks to start the chimney for some air movement within the kitchen. The user provides the input as “Turn on the Chimney”. Based on the user input, the user command is “Turn ON” and target IoT device is “Chimney”. Further, the MMI intent prediction engine will predict that the room is humid and the user intention is to reduce the humidity on the kitchen. Further, the MMI data selector (806) determines that Relevant MMI for the intensity prediction as “Smoke level, Room Temperature, and heart rate (from a smart band)”. Based on the relevant MMI, state value will be “Smoke Level: Less”, “Room_Temp:Humid”, “Heart_rate: High”. Further, the MMI correlation engine (812) provides the correlation as “Smokey kitchen with humid condition be uncomfortable for the user, if chimney speed is not correctly set”. Further, based on the relevant MMI and intensity prediction, the intensity prediction engine (814) provides the output as “turn on chimney to reduce the heat in the kitchen”. Based on the proposed method, the method can accurately predict the intensity level based on the detected user intention, only relevant smoke level, room temp and the heart rate MMI data.

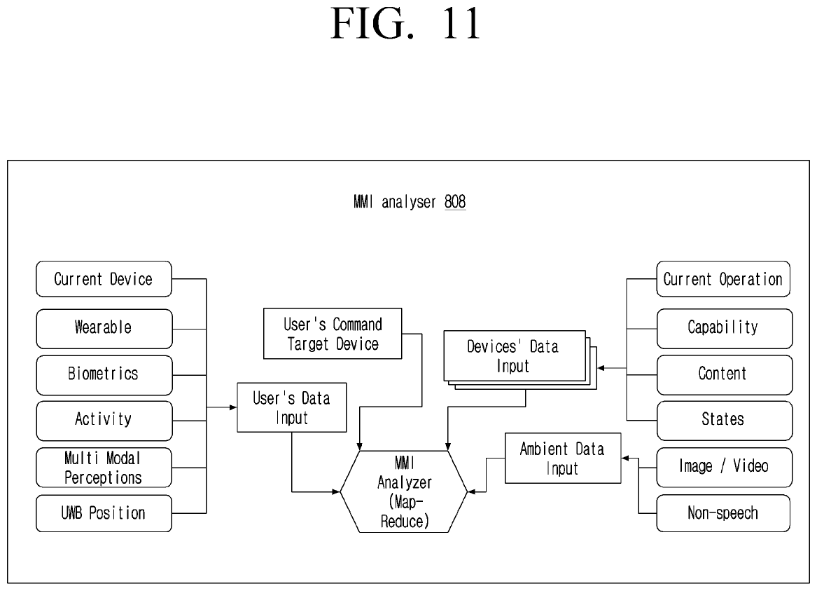

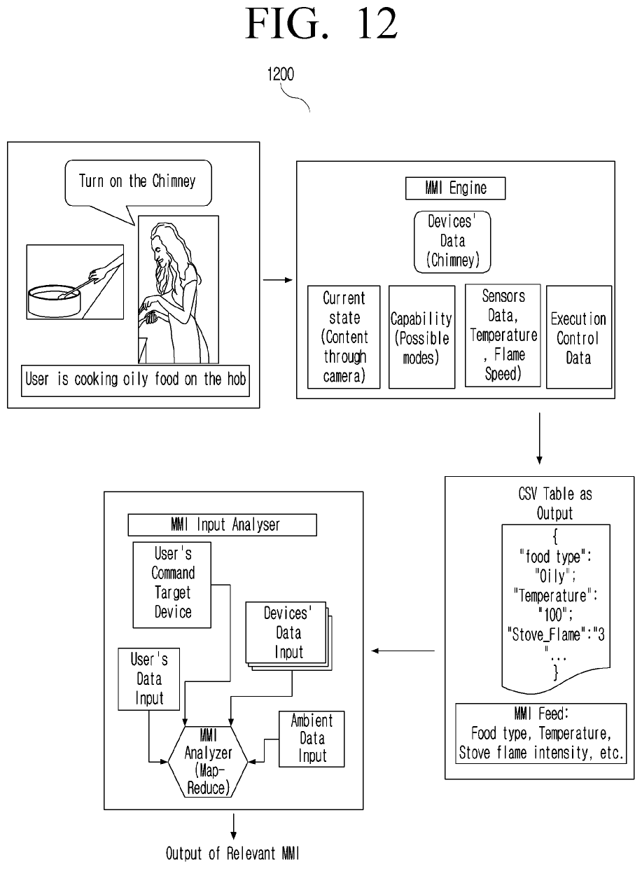

FIG. 11 and FIG. 12 are example illustrations (1200) in which operations of the MMI analyser (808) is depicted, according to an example embodiment.

The MMI engine (810) obtains the multi-modal input data through the user's command, the gesture, the position of the IOT device (600), the wearable device data etc. along with the IoT sensors, the non-speech sound, the camera and the UWB sensors data etc. Further, the MMI engine (810) converts and normalize the raw data in a tabular form such as next modules, can understand it as input. Further, the MMI engine (810) provides mapping of the wearable data and sensors data to user's current environment state. The MMI engine (810) uses the UWB data to get position information, and the MMI engine (810) uses the IoT data to get current operational states. The MMI engine (810) uses a camera and non-speech feed to get content & operation intensity status. The output of the MMI engine (810) is in a tabular format data, which is sent to the MMI correlation engine (812).

As shown in FIG. 11, the MMI analyzer (808) will act as an intelligent device selection unit, which considers the identified user's command associated with the target IoT device and reduces the available multi-modal inputs collected by various user's connected IoT devices as well as ambience input into a smaller set having impact over user's command. The MMI analyzer (808) is implemented using the map reduction technique to arrive at correlating MMI for the user's command. The map-reduction technique helps in distributed sorting and device specific capability clustering of the Multi-modal Input.

As shown in FIG. 12, the user provides the input as “Turn on the Chimney”. Based on the user input, the identified target device is the Chimney, hence, the MMI analyser (808) considers the Multi-modal input with respect to Chimney's data along with Kitchen's sensors data. Similarly, following table 1 (for example) represent map-reduced values of the target IoT device to the relevant MMI. The MMI data can be collected based on the users and the IoT devices in given IoT environment.

TABLE 1

| User's | | |
|---|---|---|
| Command | | |
| (Intent) | Target Device | Relevant MMI |
| Open the window | Curtain | User's position Data + |
| | Control/Window | Room's MMI Data |
| Clean the water | Robot Cleaner | User's Position Data + |
| spill | | Robot Cleaner's Data + |
| | | Room's MMI Data |
| Play Music | Speaker, Mobile | User's Position + Device's |
| | etc. | data + Room's MMI data |
| Wash the cloths | Washing Machine | Washing Machine's Data + |
| | | Utility Room's MMI Data |

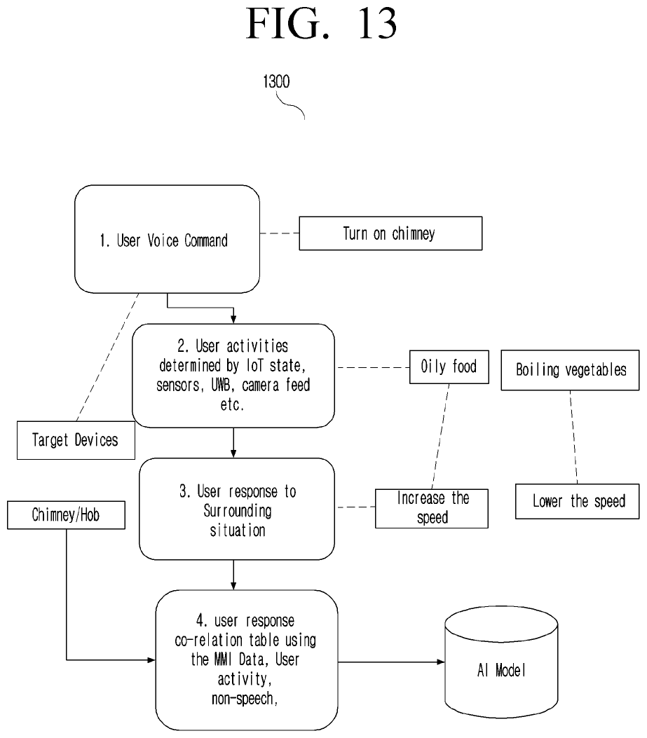

FIG. 13 is an example illustration (1300) in which the AI model is trained with the MMI data based on the user's command and the target IoT device, according to an example embodiment.

In domestic environment, the multi-modal input can be collected by many IoT devices. The user's voice command and the detected target IoT device can reduce the intended multi-modal input intelligently. At 1, the method may include receiving the user voice command. In an example, the user voice command can be, for example, but not limited to turn on chimney. At 2, the method may include determines the user activities by using the IoT state, the sensors, the UWB, the camera feed etc. In an example, the user activity can be, for example, but not limited to a cooking the oily food, boiling vegetables or the like. At 3, the method may include detecting the user response to the surrounding situation. In an example, the user response can be, for example, but not limited to an increase the chimney speed, the lower the chimney speed. At 4, the method may include getting the user response co-relation table using the MMI data, the user activity, the non-speech data, the user response and the surrounding situation. The user response co-relation table is stored, trained and updated in the AI model. The type of the AI model can be, for example, but not limited to probabilistic Naïve Bayes or Decision tree based classification models.

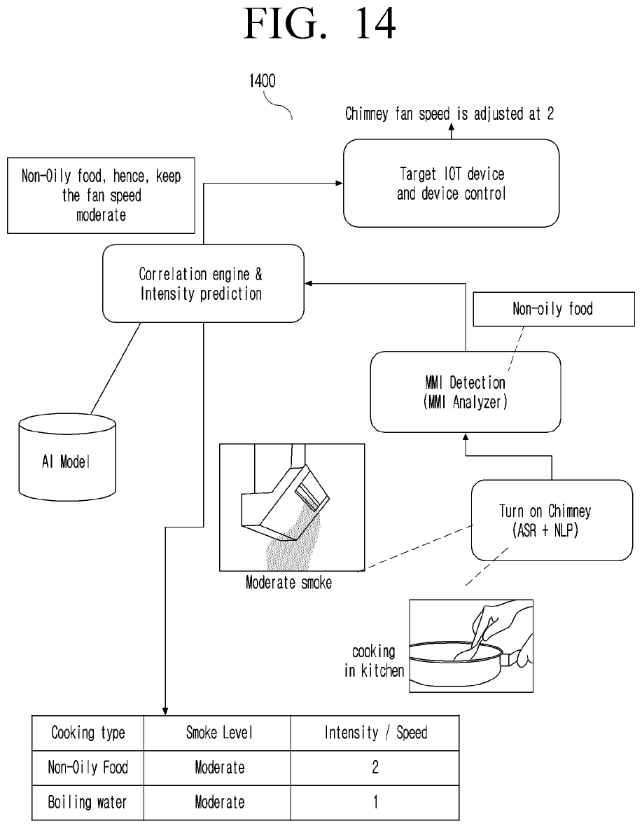

FIG. 14 is an example illustration (1400) in which operations of the intensity prediction is explained, according to an example embodiment. During start, the IoT device (600) can detect the MMI data for the complete environment. At runtime, the user gives the command as “Turn on the chimney”, the target device is the chimney. From the device mapping table, the method obtains the device data and the ambient data for the chimney. Only the device data and the ambient data will be good for the MMI data collection. Below Table 2 and Table 3 shows these MMI data columns.

TABLE 2
Available Set of Multi-Modal Input Data

| Device Data | User Data | Ambient Data |
|---|---|---|
| Connected IoT | User preferences, | Camera feed, |
| devices data, | User position, | Non-speech input, |
| Companion devices | Gesture input, etc. | Sensory input, |
| data, etc. | | External data |
| | | (weather, temp., |
| | | traffic, etc.) |

TABLE 3
Relevant Multi-Modal Input Data from MMI Analyzer

| Device Data | User Data | Ambient Data |
|---|---|---|
| Chimney state (On/Off), | | Kitchen's IoT devices' states, |
| Operation mode | | Recipe video running state, |
| (fan speed, cooking | | Non-speech input, |
| mode, clean mode), | | Smoke level (sensor data), |
| | | Camera feed, |

Further, if the user prepares the Non-Oily food, hence, the proposed methods keeps the fan speed moderate (e.g., Chimney fan speed is adjusted at 2).

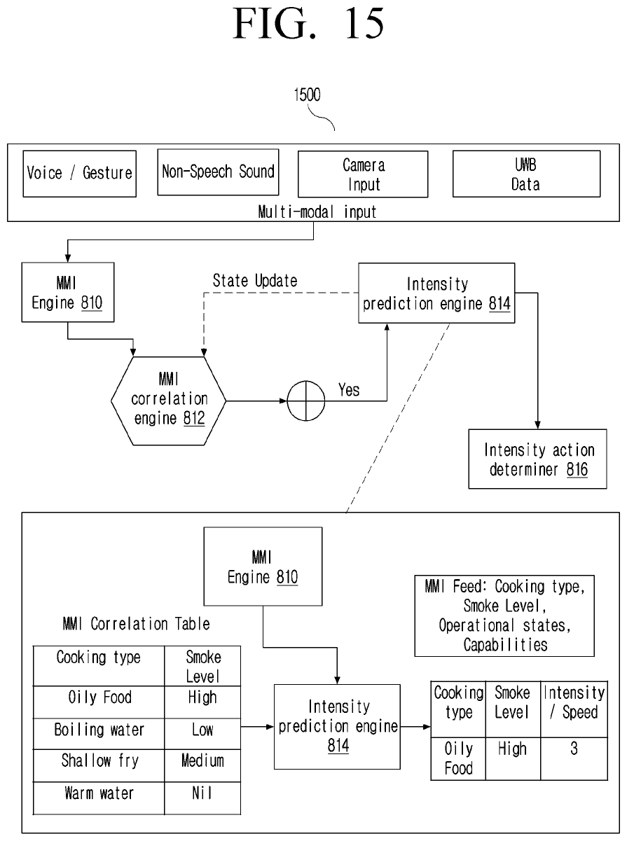

FIG. 15 is an example illustration (1500) in which operation of the intensity prediction engine (814) is explained, according to an example embodiment. The operations and functions of the user command processing unit (802), the user intent determiner (804), the MMI data selector (806), the MMI analyzer (808), the MMI engine (810), the MMI correlation engine (812), and the intensity action determiner (816) are already explained in the FIG. 8. For the sake for conciseness, the same operations are not repeated again.

For every user's home, the appliance are different, they have different settings value, different control levels etc. Such as command “start chimney”, “start washing”, “start cleaning” will go to the default mode without considering the operation parameters. The intensity prediction engine (814) understands the MMI intelligence data and predicts most suitable action/functional intensity for the target IoT devices. The intensity prediction engine (814) takes the MMI data and the MMI correlation table data as input, and predicts the action/functional intensity. The intensity prediction engine (814) is the machine learning based model and trained using Random forest. The intensity prediction engine (814) can have provision to learn through reinforcement learning based on user's personalization. During the execution of the command, the MMI data updates the command. In an example the user provides the command as “Open the window”, assume it takes 5 seconds to open complete window. The intensity prediction engine (814) can update the intensity values during 5 seconds based on a state update feedback and the updated MMI data. If in case an air flow starts suddenly, wind is of storm type etc. then functional intensity can be changed based on the user command.

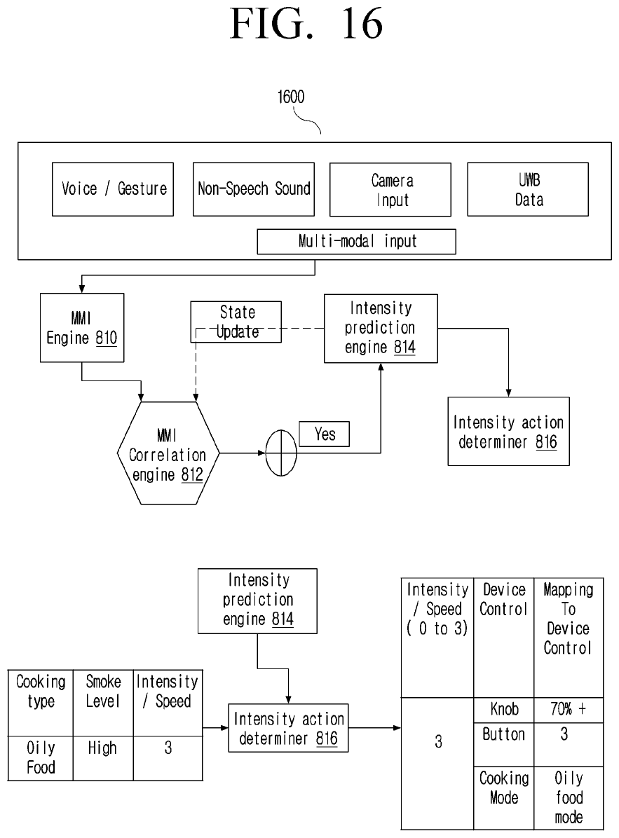

FIG. 16 is an example scenario (1600) in which operations of the intensity action determiner (816) is explained, according to an example embodiment. The operations and functions of the user command processing unit (802), the user intent determiner (804), the MMI data selector (806), the MMI analyzer (808), the MMI engine (810), the MMI correlation engine (812), and the intensity prediction engine (814) are already explained in the FIG. 8. For the sake for conciseness, the same operations are not repeated again.

Based on the output of the intensity prediction engine (814), the determined intensity needs to be executed on one or more IoT device in user's home. In real life, different device models can have different modes and levels. The intensity action determiner (816) takes IoT capabilities and execution control data, and maps the IoT capabilities and execution control data with the determined intensity. The control commands are prepared and executed. It's a dynamic mapper and deep link creator program, which generates the executable deep link on the go based on input parameters. In an example, for the command “Clean the water spill”, both the fan and the cleaner are set to determined intensity level by different control mechanism.

The user of the IoT device (600) is cooking oily food on the kitchen hob, and gave the command (e.g., Turn on Exhaust or the like) to start the chimney. The MMI analyzer (808) detects the MMI data (e.g., food type, smoke level, temperature, stove flame speed) to identify the relevant factors contributing towards handling the user command. The intensity action determiner (816) will correlate the intent of the user command to the map-reduced relevant multi-modal input feed (e.g., oily food, higher smoke levels), to dynamically predict the intensity (e.g., higher fan speed or the like) & mode of chimney device.

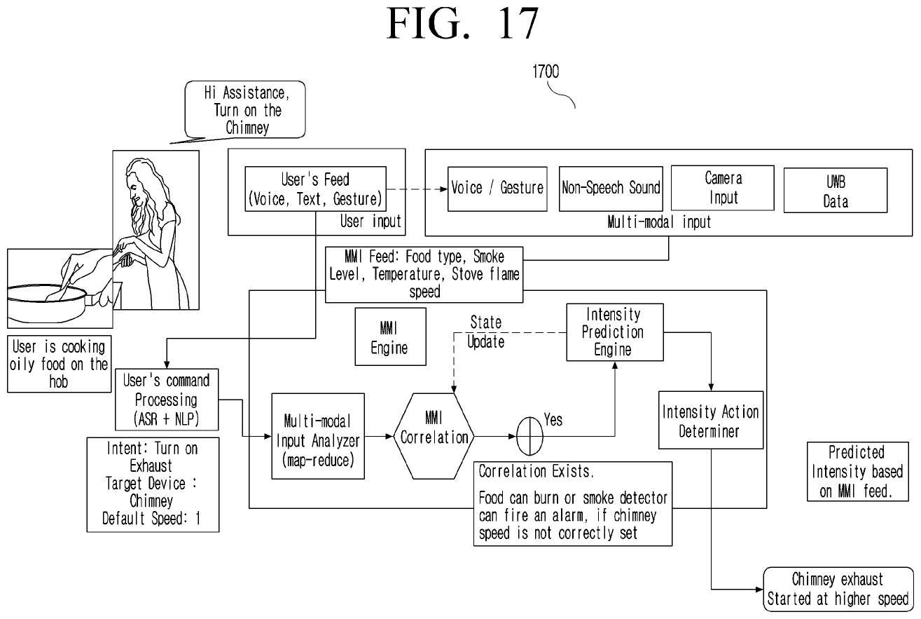

FIG. 17 is an example scenario (1700) in which situational execution intensity prediction is explained, according to an example embodiment. The user cooks the oily food on the kitchen hob, and gave the command to start the chimney. The intensity action determiner (816) will correlate the contextual user command to the received multi-modal input feed (e.g., oily food, higher smoke levels or the like), to dynamically predict the intensity (e.g., higher fan speed) and mode of chimney to appropriately handle a user requested action.

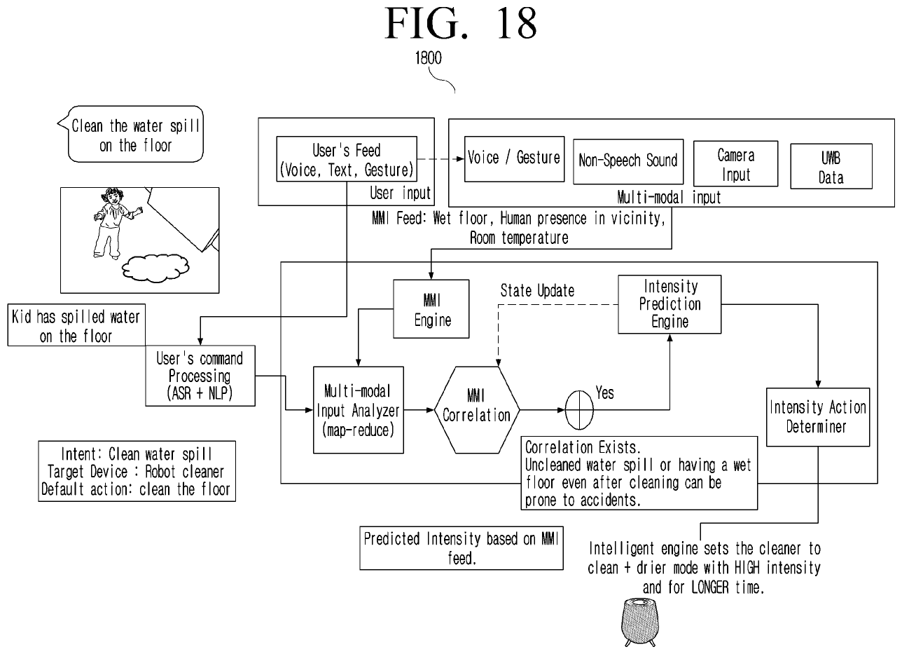

FIG. 18 is an example scenario (1800) in which the situation execution intensity prediction on more than one target IoT devices is explained, according to an example embodiment. Consider, the water spilled on the floor and the user asks the robot vacuum cleaner to clean the water spill. The intensity action determiner (816) will correlate the contextual user command to receive the multi-modal input feed (e.g., wet floor, human presence or the like) to dynamically predict the intensity (e.g., rob cleaner mode) and duration of activity to appropriately handle the user requested action.

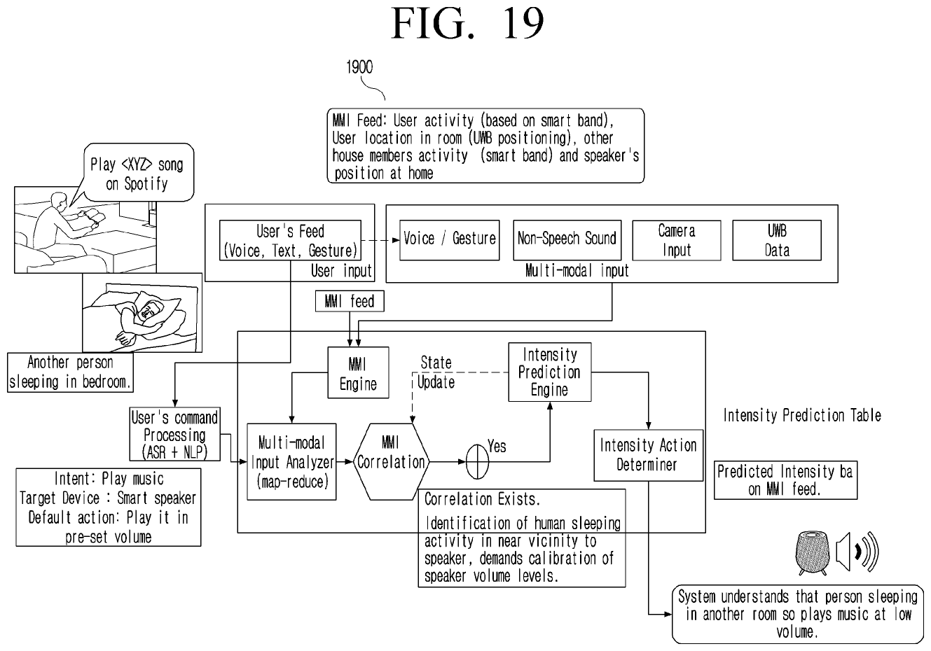

FIG. 19 is an example scenario (1900) in which the situation execution intensity prediction is explained based on the identified human presence and the activity, according to an example embodiment. The user is working from the home and asks a virtual assistance running in the smart phone to play a music on a music application. The IoT device (600) will correlate the contextual user command to the received multi-modal input feed (e.g., speaker location, human presence & activity), to dynamically predict the intensity (e.g., speaker volume) to appropriately handle the user requested action.

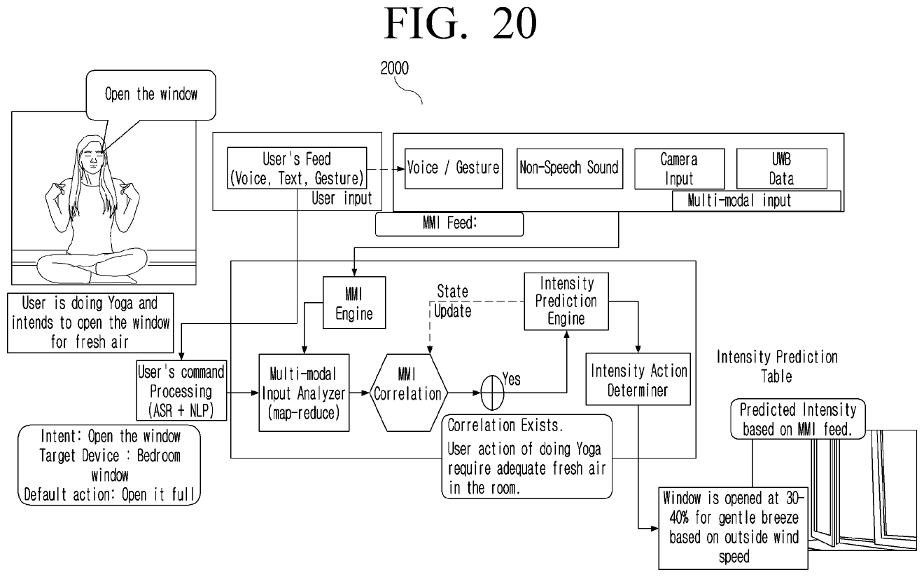

FIG. 20 is an example scenario (2000) in which the dynamic execution intensity prediction is explained, according to an example embodiment. The user performs a Yoga in a room and commands to the IoT device as “open the window”. The IoT device (600) will dynamically calibrate the intensity of the response on external detected conditions to handle the user command. While the IoT device operation is based on an intent prediction engine output, dynamic factors (e.g., wind flow or the like) can be affected based on the external condition. Hence, in such scenarios, the ‘State update’ feedback provided to the correlation engine (812) to ensure that the intensity prediction output is normalized continuously to produce accurate intensity results. For example, in current scenario, initial prediction was for 40-50% intensity, but, due to dynamic factors normalization, the final output is recalibrated to 30-40% instead.

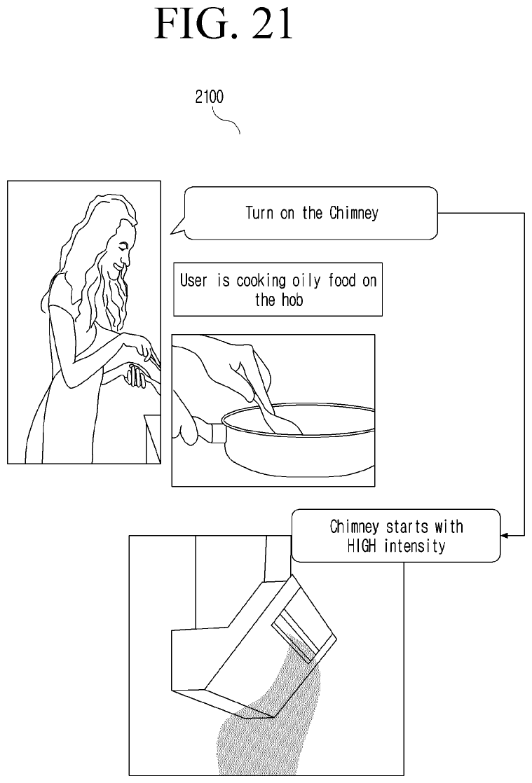

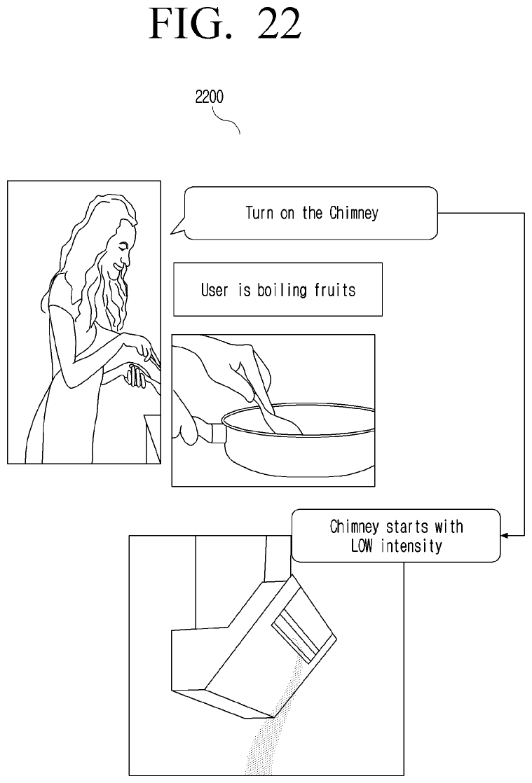

FIG. 21 and FIG. 22 are example illustrations (2100 and 2200) in which the situational execution intensity determination is explained based on the multi-modal input data received at the moment of reception of the user command, according to an example embodiment.

As shown in FIG. 21, the user provides the input as “Turn on the Chimney”. Based on the proposed method, the virtual assistance understands that the user context (e.g. user is cooking the oily food on the kitchen hob). Hence, the proposed method understands, using the multi-modal data, presence of the oily food content which is likely to produce more smoke, and intelligently sets the chimney to high intensity.

As shown in FIG. 22, the user provides the input as “Turn on the chimney”. Based on the proposed method, the virtual assistance understands that the user context (e.g. user is boiling fruits). Hence, the proposed method understands the multi-modal data and intelligently controls the chimney to correct intensity (e.g., chimney starts with the low intensity).

Each embodiment herein may be used in combination with any other embodiment(s) described herein.

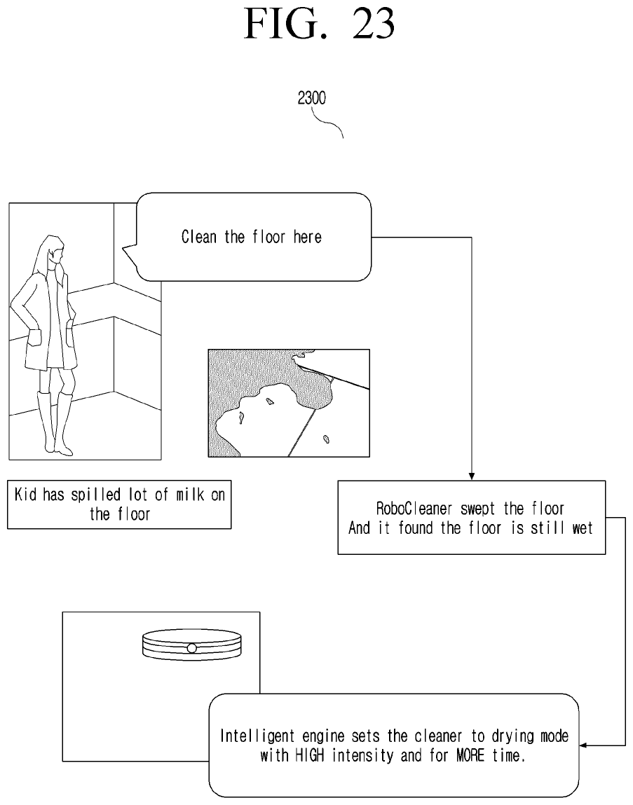

FIG. 23 to FIG. 28 are example scenarios (2300-2800) in which the execution intensity is determined by correlation of the multi-modal data input with the user command, according to an example embodiment.

As shown in FIG. 23, consider the scenario, kid has spilled less of milk on the floor. The user of the virtual assistance provides the input as “Clean the floor here” to the Robot-Cleaner. The Robot-Cleaner swept the floor and the Robot-Cleaner found that the floor is dry. Further, the Robot-Cleaner sets itself drying mode with low intensity and less time. The proposed system understands the multi-modal data, intelligently controls the robot cleaner speed and time to correct intensity.

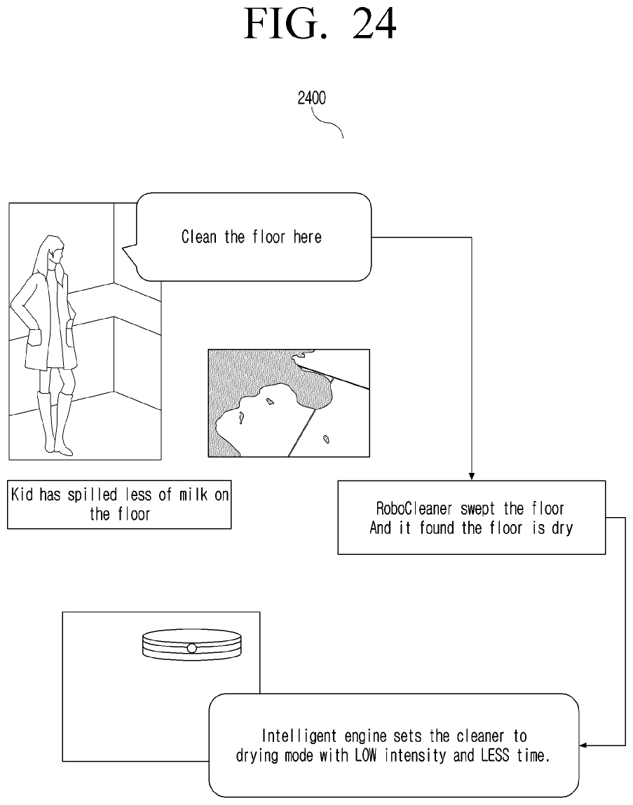

As shown in FIG. 24, the user provides the input as “Clean the floor here” to the Robot-Cleaner. The Robot-Cleaner swept the floor and it found that the floor is still wet, so that the Robot-Cleaner sets itself the cleaner to the drying mode with high intensity and for more time. Using multi-modal data correlation, the proposed method understands that after sweeping floor is wet and based environment it could take time to dry.

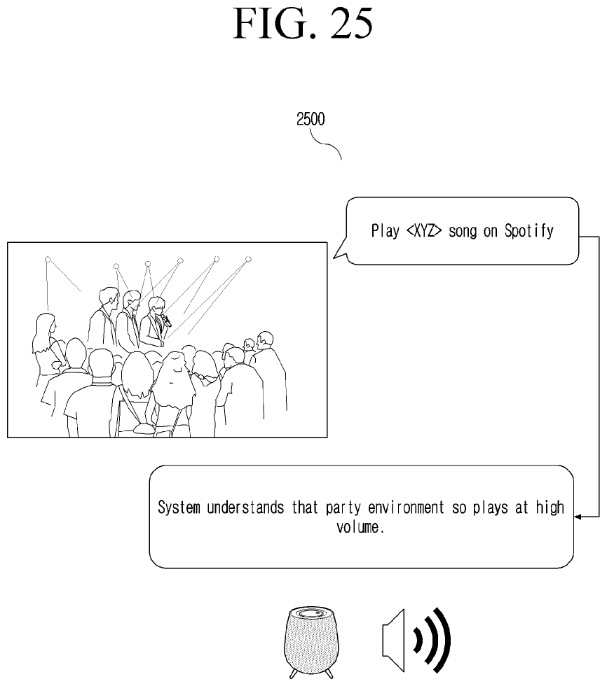

As shown in the FIG. 25, the user provides the input as “Play <XYZ> song on the Spotify® running in the smart phone. Based on the proposed methods, the smart phone understands that the smart phone is in a party environment so that the smart phone plays the song with high volume.

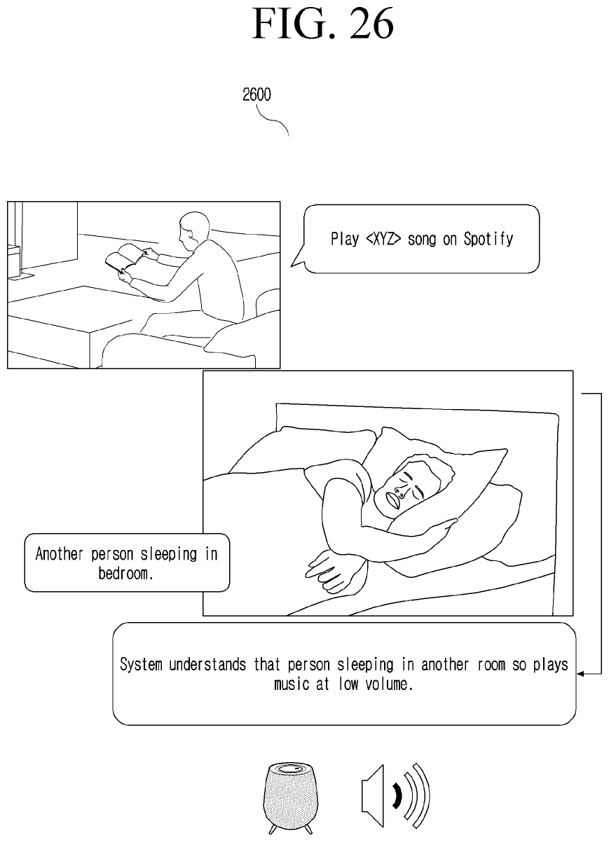

As shown in the FIG. 26, the user provides the input as “Play <XYZ> song on Spotify® running in the smart phone and the virtual assistance detects that another person sleeping in the bedroom. Based on the proposed method, the smart phone understands that the person sleeping in another room so that the Spotify® plays the music with low volume.

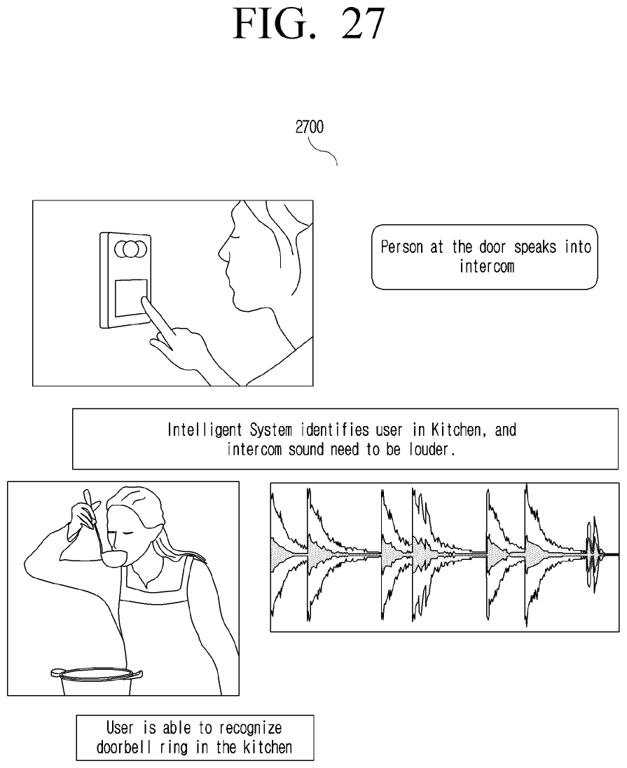

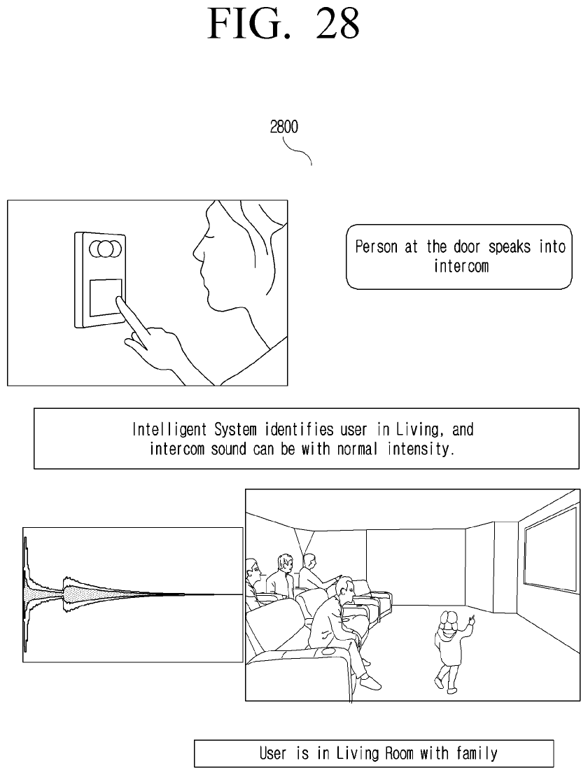

As shown in FIG. 27, the person at the door speaks into a smart intercom speaker. Based on the proposed method, the smart intercom speaker identifies that the user is in the kitchen, and the smart intercom speaker sound need to be louder. As shown in FIG. 28, the person at the door speaks into the smart intercom speaker. Based on the proposed method, the smart intercom speaker identifies that the user is in a living room, and the smart intercom speaker sound can be with normal intensity.

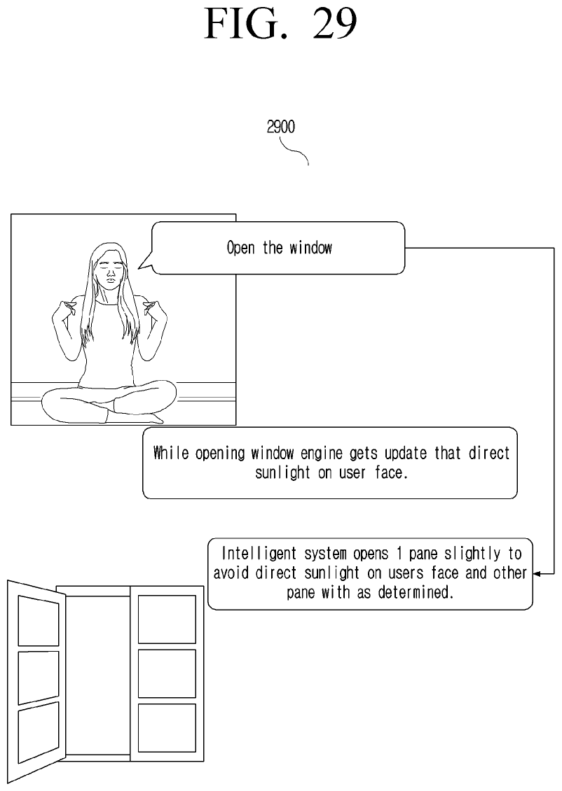

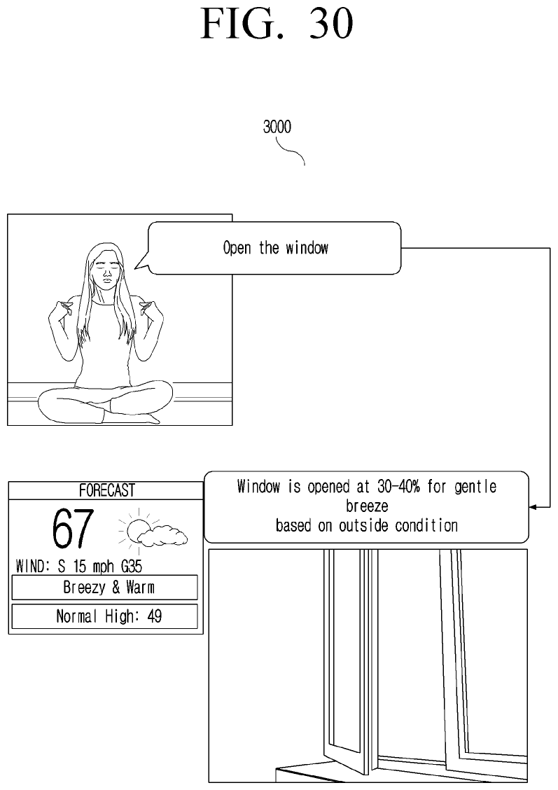

FIG. 29 and FIG. 30 are another example scenarios (2900 and 3000) in which situational execution intensity determination is depicted based on the multi-modal input data received at the moment of reception of the user command, according to an example embodiment. “Based on” as used herein covers based at least on.

As shown in FIG. 29, the user provides the comments as “Open the window”. While opening window, the virtual assistance detects that the outside environment is warm and breezy, and opens only part of window. As shown in FIG. 30, the user provides the comments as “Open the window”. While opening the window, the virtual assistance gets update that direct sunlight on the user face, so that the virtual assistance opens an one pane slightly to avoid direct sunlight on the users face and other pane is closed.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for executing a user input in an Internet of Things (IoT) environment, the method comprising:
receiving, by at least one IoT device, the user input from a user of the at least one IoT device to execute at least one task associated with the at least one IoT device in the IoT environment;
acquiring, by the at least one IoT device, multimodal data of the IoT environment based on the user input;
predicting, by the at least one IoT device, a task execution intensity for the at least one task associated with the at least one IoT device based on the user input and the multimodal data; and
executing, by the at least one IoT device, the at least one task associated with the at least one IoT device with the predicted task execution intensity.

2. The method as claimed in claim 1, further comprising:
monitoring, by the at least one IoT device, the task execution intensity for the at least one task as a feedback over a period of time; and
executing, by the at least one IoT device, the at least one task associated with the at least one IoT device based on the feedback.

3. The method as claimed in claim 1, wherein acquiring, by the at least one IoT device, the multimodal data of the IoT environment comprises:
determining, by the at least one IoT device, a multimodal context of the IoT environment relevant to the at least one task associated with the at least one IoT device based on the received user input; and
acquiring, by the at least one IoT device, the multimodal data of the IoT environment corresponding to the determined multimodal context.

4. The method as claimed in claim 3, wherein the multimodal context comprises at least one of a context of the user, a context of the at least one IoT device and an ambient context, and wherein the context of the user context is determined from one or more derived input from the multimodal data, pertaining to an user activity, and state of connected IoT devices, wherein the ambient context is determined from one or more derived inputs from IoT device data, non-speech scene detection, sensory output, and an external parameter.

5. The method as claimed in claim 1, wherein the multimodal data comprises at least one of: a gesture of the user, Ultra-wideband (UWB) position of the at least one IoT device, data associated with the at least one IoT device, at least one sensor input, feed associated with an imaging device, voice assistant information, and non-speech information.

6. The method as claimed in claim 1, wherein the task execution intensity comprises at least one of: a functional mode of the at least one IoT device, a position of the at least one IoT device, a movement of the at least one IoT device, and a control function of the at least one IoT device.

7. The method as claimed in claim 1, wherein the multimodal data is acquired at least by:
receiving at least one of the user input, a gesture of the user, Ultra-wideband (UWB) position of the at least one IoT device, data associated with the at least one IoT device, at least one sensor input, feed associated with an imaging device, voice assistant information, and non-speech information to generate the multimodal data; and
converting and normalizing the generated multimodal data.

8. The method as claimed in claim 1, wherein the multimodal data is acquired by:
mapping of a wearable device in the IoT environment and at least one sensor data in the IoT environment to obtain a current environment state of the user and the at least one IoT device;
obtaining a position information of the user and the at least one IoT device using a UWB data;
obtaining a current operational state of the at least one IoT device using an IoT data;
obtaining a content and operation intensity status using data from an imaging device and a non-speech feed; and
acquiring the multimodal data based on the current environment state of the user, the current environment state of the at least one IoT device, the obtained position information of the user and the at least one IoT device, the obtained current operational state of the at least one IoT device and the obtained content and operation intensity status.

9. The method as claimed in claim 7, wherein the multimodal data is updated over a period of time, using a data driven model, based on at least one of the user behavior, an user usage pattern and the at least one IoT device, wherein the multimodal data is processed using a map reduction technique.

10. The method as claimed in claim 1, wherein the task execution intensity is determined using at least one of a machine learning (ML) based technique, a Random forest technique, a clustering based technique and a decision tree based classifier, wherein the task execution intensity is determined based on at least one of capability of the at least one IoT device, a state of the at least one IoT device, and an execution control data associated with the at least one IoT device.

11. A method for executing a user input in an internet of things (IoT) environment, the method comprising:
receiving, by at least one IoT device comprising a processor, a user input from a user of the at least one IoT device to execute at least one task associated with the at least one IoT device in the IoT environment;
determining, by the at least one IoT device, a multimodal context of the IoT environment relevant to the at least one task associated with the at least one IoT device based on the received user input;
retrieving, by the at least one IoT device, multimodal data of the IoT environment corresponding to the determined multimodal context;
determining, by the at least one IoT device, a task execution intensity for the at least one task associated with the at least one IoT device based on the retrieved multimodal data; and
executing, by the at least one IoT device, the at least one task associated with the at least one IoT device using the determined task execution intensity.

12. An internet of things (IoT) device, comprising:
a processor;
a memory storing at least one of a state of the IoT device and an activity of the IoT device; and
a multimodal input based task controller, comprising circuitry, coupled with the processor and the memory, and configured to:
receive the user input from a user of the at least one IoT device to execute at least one task associated with the at least one IoT device in the IoT environment;
acquire multimodal data of the IoT environment based on the user input;
predict a task execution intensity for the at least one task associated with the at least one IoT device based on the user input and the multimodal data; and
execute the at least one task associated with the at least one IoT device based on the predicted task execution intensity.
